(19) United States
(12) Patent Application Publication
(10) Pub. No.: US 2024/0419626 A1
(43) Pub. Date: Dec. 19, 2024

(54) PERFORMANCE EVALUATOR FOR A HETEROGENOUS HARDWARE PLATFORM

(71) Applicant: Xilinx, Inc., San Jose, CA (US)

(72) Inventors: Paul Robert Schumacher, Berthoud, CO (US); Anurag Dubey, Boulder, CO (US)

(73) Assignee: Xilinx, Inc., San Jose, CA (US)

(21) Appl. No.: 18/336,777

(22) Filed: Jun. 16, 2023

(51) Int. Cl. G06F 15/78

(52) U.S. Cl. CPC G06F 15/7807; G06F 15/7842

(57) ABSTRACT

Performance evaluation of a heterogeneous hardware platform includes implementing a traffic generator design in an integrated circuit. The traffic generator design includes traffic generator kernels including a traffic generator kernel implemented in a data processing array of the integrated circuit and a traffic generator kernel implemented in a programmable logic of the integrated circuit. The traffic generator design is executed in the integrated circuit. The traffic generator kernels implement data access patterns by, at least in part, generating dummy data. Performance data is generated from executing the traffic generator design in the integrated circuit. The performance data is output from the integrated circuit.

### TECHNICAL FIELD

This disclosure relates to integrated circuits (ICs) and, more particularly, to evaluating the performance of a heterogeneous hardware platform implemented as a System-on-Chip.

### BACKGROUND

Modern integrated circuits, often referred to as System-on-Chips (SoCs), are capable of implementing complex architectures that include a variety of different types of compute circuits. Each different type of compute circuit has its own specific circuit architecture such that the compute circuit types are heterogeneous with respect to one another. In some cases, each different type of compute circuit is suited for performing a particular type of operation. Further, each different type of compute circuit often provides different types of connectivity to the other portions of the SoC that also may influence how the compute circuits interact with one another as part of a larger design. For purposes of illustration, examples of different compute circuits available within an SoC can include, but are not limited to, a processor subsystem having one or more processor cores each capable of executing program code, programmable circuitry or logic capable of implementing various user circuits, and/or a data processing array.

Building a user design within such a complex SoC is difficult and time consuming. Understanding the nuances of the different compute circuits available and the architecture of the SoC as a whole is often necessary to determine which compute circuits to use for implementing different functions of the user's design. Often users lack a sufficient level of understanding to fully leverage the computational capabilities of the heterogeneous SoC architecture. Only after one acquires a deep understanding of the hardware may one comprehend how to efficiently utilize the hardware to the fullest extent possible. This is problematic in that one may be apprehensive to invest the time and money necessary to evaluate a given heterogeneous hardware platform without some level of understanding of the capabilities of that heterogeneous hardware platform.

### SUMMARY

In one or more example implementations, a method includes implementing a traffic generator design in an integrated circuit. The traffic generator design includes traffic generator kernels including a traffic generator kernel implemented in a data processing array of the integrated circuit and a traffic generator kernel implemented in a programmable logic of the integrated circuit. The method includes executing the traffic generator design in the integrated circuit. The traffic generator kernels implement data access patterns by, at least in part, generating dummy data. The method includes generating performance data from the executing the traffic generator design in the integrated circuit. The method includes outputting the performance data from the integrated circuit.

The foregoing and other implementations can each optionally include one or more of the following features, alone or in combination. Some example implementations include all the following features in combination.

In some aspects, the data access patterns implemented by the traffic generator kernels mimic data access patterns of application-specific kernels.

In some aspects, the method includes configuring the traffic generator design to implement the data access patterns.

In some aspects, the method includes configuring the traffic generator design to use selected interfaces between the data processing array and one or more other subsystems of the integrated circuit.

In some aspects, the selected interfaces are selected from a Global Memory Input/Output interface and a Programmable Logic Input/Output interface.

In some aspects, the method includes configuring the traffic generator design to implement a number of graphs in the data processing array. Each graph can include one or more traffic generator kernels. In other aspects, the method can include implementing a specified number of traffic generator kernels in one or more of the graphs.

In some aspects, the method includes configuring the traffic generator design so that the traffic generator kernel in the data processing array broadcasts data to a plurality of other traffic generator kernels in the data processing array.

In some aspects, the method includes modifying execution of the traffic generator design in the integrated circuit in response to receiving user-specified runtime parameters.

In some aspects, the traffic generator kernel of the data processing array is executed in a first tile of the data processing array and sends data over a first data path of a plurality of data paths to a second tile of the data processing array. The runtime parameters cause the traffic generator kernel of the data processing array to send data over a second and different data path of the plurality of data paths to the second tile.

In some aspects, the plurality of data paths include a shared memory connection, a cascade connection, and a streaming interconnect connection.

In some aspects, one or more of the traffic generator kernels are activated or deactivated in response to the user-specified runtime parameters.

In some aspects, the method includes implementing a host traffic generator application in a processor system of the integrated circuit that executes concurrently with the traffic generator design in response to user-specified configuration parameters.

In one or more example implementations, an integrated circuit includes a data processing array configured to implement a first data traffic generator of a traffic generator design for the integrated circuit. The integrated circuit includes a programmable logic configured to implement a second traffic generator kernel of the traffic generator design. The traffic generator design is executed in the integrated circuit such that the traffic generator kernels implement data access patterns by, at least in part, generating dummy data. The data processing array and the programmable logic are configured to generate performance data from executing the traffic generator design in the integrated circuit.

The foregoing and other implementations can each optionally include one or more of the following features, alone or in combination. Some example implementations include all the following features in combination.

In some aspects, the data access patterns implemented by the traffic generator kernels mimic data access patterns of application-specific kernels.

In some aspects, the traffic generator design is configurable to implement the data access patterns.

In some aspects, the traffic generator design is configurable using user-specified parameters to use selected interfaces between the data processing array and one or more other subsystems of the integrated circuit.

In some aspects, the traffic generator design is configurable to implement a user-specified number of graphs in the data processing array, wherein each graph includes one or more traffic generator kernels. In other aspects, the method can include implementing a specified number of traffic generator kernels in one or more of the graphs.

In some aspects, execution of the traffic generator design is modified during runtime in response to receiving user-specified runtime parameters.

In some aspects, the first traffic generator kernel is executed in a first tile of the data processing array and sends data over a first data path of a plurality of data paths to a second tile of the data processing array. The runtime parameters cause the first traffic generator kernel to send data over a second and different data path of the plurality of data paths to the second tile.

In some aspects, the plurality of data paths include a shared memory connection, a cascade connection, and a streaming interconnect connection.

In one or more example implementations, a system includes one or more hardware processors configured (e.g., programmed) to initiate and/or execute operations as described within this disclosure.

In one or more example implementations, a computer program product includes one or more computer readable storage mediums having program instructions embodied therewith. The program instructions are executable by computer hardware, e.g., a hardware processor, to cause the computer hardware to initiate and/or execute operations as described within this disclosure.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

The inventive arrangements are illustrated by way of example in the accompanying drawings. The drawings, however, should not be construed to be limiting of the inventive arrangements to only the particular implementations shown. Various aspects and advantages will become apparent upon review of the following detailed description and upon reference to the drawings.

FIG. 1 illustrates an example computing environment including a data processing system and an accelerator for use with the inventive arrangements.

FIG. 2 illustrates an example implementation of an integrated circuit.

FIGS. 3A, 3B, and 3C illustrate examples of different tiles included in a data processing array.

FIG. 4 illustrates example connectivity between a data processing array and other subsystems of an integrated circuit.

FIG. 5 illustrates an example of a traffic generator design.

FIGS. 6A, 6B, 6C, and 6D illustrate different ways of conveying data among tiles of a data processing array.

FIG. 7 illustrates certain operative features implemented using runtime parameters.

FIG. 8 illustrates an example method of determining the performance of a heterogeneous hardware platform.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to integrated circuits (ICs) and, more particularly, to evaluating the performance of a heterogeneous hardware platform implemented as a System-on-Chip (SoC). In accordance with the inventive arrangements described within this disclosure, an SoC having heterogeneous compute circuitry may be loaded with a design that is operable to emulate operation of a particular type of application intended for implementation in the SoC. The design is referred to herein as a traffic generator design. The traffic generator design may be a pre-created design. The inventive arrangements may be used to emulate the operation of different alternative architectures for a user design in which different functions and/or operations are allocated to different types of the compute circuits available in the SoC.

The traffic generator design, as implemented in the SoC and executed, includes a plurality of traffic generator kernels. The traffic generator design also specifies potential connectivity among the traffic generator kernels and/or other resources of the SoC. Each traffic generator kernel is capable of mimicking operation and/or implementation of a particular function referred to herein as an application-specific kernel without performing the actual function of the application-specific kernel. For example, a traffic generator kernel is capable of consuming dummy data and/or generating dummy data based on specified data access patterns to mimic operation of an application-specific kernel that actually performs the function. A traffic generator kernel configured to mimic operation of an application-specific kernel that performs convolution, for example, will read and/or write data as the convolution kernel would and have a runtime behavior that mimics the runtime behavior of the convolution kernel. The data that is read and/or written by the traffic generator kernel is dummy data as the traffic generator kernel does not actually perform convolution. In this regard, each traffic generator kernel may be implemented as a standardized kernel that is configurable with certain configuration parameters and/or runtime parameters to mimic operation of a particular function as if that particular function was implemented using the same type of compute circuit used to host and/or implement the traffic generator kernel.

As the traffic generator design, including configured traffic generation kernels, operates at runtime, performance data is generated and collected. Analysis of the performance data indicates which portions of the architecture, as implemented in the SoC by the traffic generator design, meet certain user-specified design requirements. Analysis of the performance data also may result in recommendations that may be provided to the user specifying how to achieve improved performance. It should be appreciated that the performance data is obtained without the user having to create a functional design for a given application. Rather, the user may select a particular, pre-built traffic generator design that is reflective of the particular application the user intends to implement. The user also may configure the traffic generator design with particular user-specified parameters and execute the traffic generator design to determine whether performance of the architecture specified by the traffic generator design, as configured, will meet the user's requirements.

Further aspects of the inventive arrangements are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

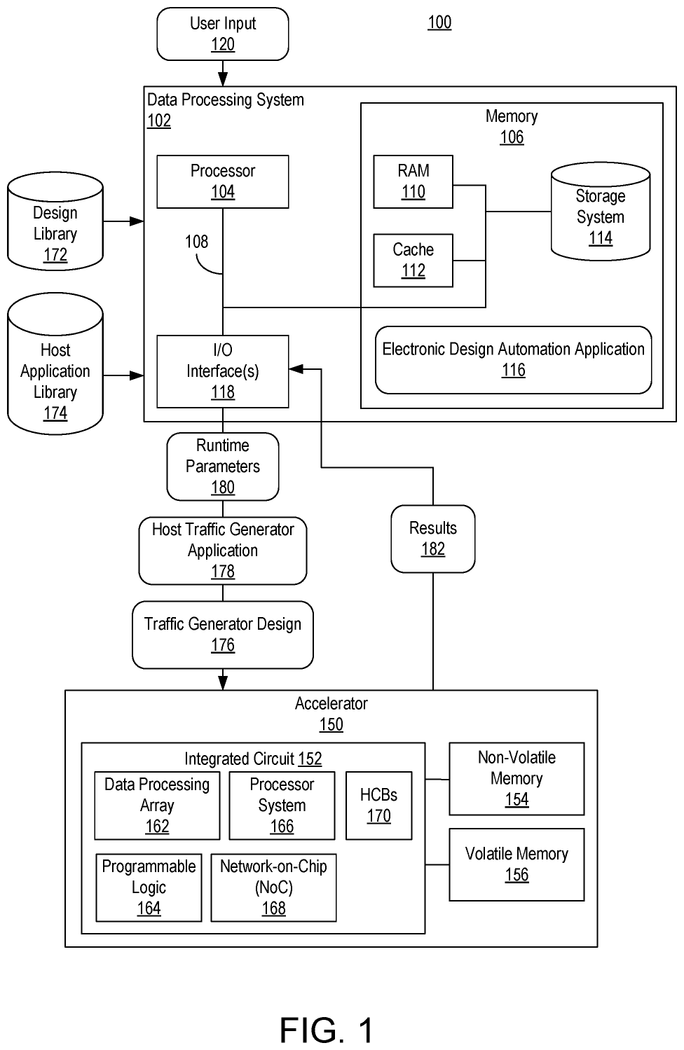

FIG. 1 illustrates an example computing environment 100 including a data processing system 102 and an accelerator 150 for use with the inventive arrangements. Data processing system 102 may be implemented as a computer capable of performing certain operations described herein. It should be appreciated that any of a variety of data processing systems may implement the various functions described herein. In some examples, different computers may perform different operations as described. For example, one computer may perform operations relating to setting up a traffic generator design within an SoC of accelerator 150 while another computer may perform operations relating to analyzing the performance data obtained from execution of the traffic generator design by the SoC.

As defined herein, the term “data processing system” means one or more hardware systems configured to process data, each hardware system including at least one hardware processor and memory, wherein the hardware processor is programmed with computer-readable instructions that, upon execution, initiate operations. Data processing system 102 can include a processor 104, a memory 106, and a bus 108 that couples various system components including memory 106 to processor 104.

Processor 104 may be implemented as one or more hardware circuits, e.g., integrated circuits, capable of carrying out instructions contained in program code. In an example, processor 104 is implemented as a CPU. Host processor 104 may be implemented using a complex instruction set computer architecture (CISC), a reduced instruction set computer architecture (RISC), a vector processing architecture, or other known architectures. Example processors include, but are not limited to, processors having an x86 type of architecture (IA-32, IA-64, etc.), Power Architecture, ARM processors, and the like.

Bus 108 represents one or more of any of a variety of communication bus structures. By way of example, and not limitation, bus 108 may be implemented as a Peripheral Component Interconnect Express (PCIe) bus. Host system 102 typically includes a variety of computer system readable media. Such media may include computer-readable volatile and non-volatile media and computer-readable removable and non-removable media.

Memory 106 can include computer-readable media in the form of volatile memory, such as RAM 110 and/or cache memory 112. Host system 102 also can include other removable/non-removable, volatile/non-volatile computer storage media. By way of example, storage system 114 can be provided for reading from and writing to a non-removable, non-volatile magnetic and/or solid-state media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 108 by one or more data media interfaces. Memory 106 is an example of at least one computer program product.

Memory 106 is capable of storing computer-readable program instructions that are executable by processor 104. For example, the computer-readable program instructions can include an operating system, one or more application programs, other program code such as an Electronic Design Automation (EDA) application 116, and program data. Processor 104, in executing the computer-readable program instructions, is capable of performing the various operations described herein that are attributable to a computer. It should be appreciated that data items used, generated, and/or operated upon by data processing system 102 are functional data structures that impart functionality when employed by data processing system 102.

As defined within this disclosure, the term “data structure” means a physical implementation of a data model's organization of data within a physical memory. As such, a data structure is formed of specific electrical or magnetic structural elements in a memory. A data structure imposes physical organization on the data stored in the memory as used by an application program executed using a processor.

Data processing system 102 may include one or more Input/Output (I/O) interfaces 118 communicatively linked to bus 108. I/O interface(s) 118 allow data processing system 102 to communicate with one or more external devices such as accelerator 150. Examples of I/O interfaces 118 may include, but are not limited to, network cards, modems, network adapters, hardware controllers, etc. Examples of external devices also may include devices that allow a user to interact with data processing system 102 (e.g., a display, a keyboard, and/or a pointing device).

Data processing system 102 is only one example implementation. Data processing system 102 can be practiced as a standalone device (e.g., as a user computing device or a server, as a bare metal server), in a cluster (e.g., two or more interconnected computers), or in a distributed cloud computing environment (e.g., as a cloud computing node) where tasks are performed by remote processing devices that are linked through a communications network. In a distributed cloud computing environment, program modules may be located in both local and remote computer system storage media including memory storage devices.

In an example implementation, I/O interface 118 may be implemented as a PCIe adapter. Data processing system 102 and accelerator 150 communicate over a communication channel, e.g., a PCIe communication channel. In other arrangements, Data processing system 102 and accelerator 150 may communicate over other communication channels such as Universal Serial Bus (USB) or other alternative. Accelerator 150 may be implemented as a circuit board that couples to data processing system 102. Accelerator 150 may, for example, be inserted into a card slot, e.g., an available bus and/or PCIe slot, of data processing system 102.

Accelerator 150 may include an SoC such as IC 152, a non-volatile memory 154 coupled to IC 152, and a volatile memory 156 also coupled to IC 152. Non-volatile memory 154 may be implemented as flash memory. Volatile memory 156 may be implemented as a RAM (e.g., DDR). In the example, IC 152 may be implemented to include a variety of different subsystems. In this regard, IC 152 is an example of a heterogeneous hardware platform. Each subsystem includes compute circuits of a particular type and/or architecture. For example, IC 152 is illustrated as including subsystems such as a data processing array 162, a processor system 166, a programmable logic (PL) 164, a Network-on-Chip (NoC) 168, and one or more hardened circuit blocks (HCBs) 170.

In the example, data processing system 102 may execute EDA application 116. A user may interact with EDA application 116 and select a particular traffic generator design from a design library 172. Design library 172 includes a plurality of different traffic generator designs. Each of the different traffic generator designs of design library 172 may be a pre-created design. In one or more examples, each traffic generator design may be a configuration bitstream (e.g., a pre-configured bitstream). Each traffic generator design is capable of emulating a particular type of application and/or an application with a particular architecture. Examples of traffic generator designs included in design library 172 may include, but are not limited to, a traffic generator design intended to emulate an image processing application within IC 152, a traffic generator design intended to emulate machine-learning based inference within IC 152, or the like. Further, design library 172 may include multiple different traffic generator designs for a given application, where each different traffic generator design implements an alternative architecture (e.g., an alternative placement or partitioning of kernels and connectivity among the kernels). For purposes of illustration, the traffic generator designs of design library 172 each specify one or more traffic generator kernels for implementation in data processing array 162, one or more traffic generator kernels for implementation in PL 164, or one or more traffic generator kernels for implementation in both data processing array 162 and PL 164. Connectivity of the traffic generator kernels of the different data traffic designs as implemented in the different subsystems may be via direct connections, through NoC 168, through PL 164, or various combinations thereof.

As an illustrative and nonlimiting example, the traffic generator designs in design library 172 may correspond to applications determined by surveying existing designs of IC 152 or other similar SoCs. The applications commonly implemented in IC 152 or other similar SoC may be profiled to determine a set of best practices and/or common implementations relating to the placement of kernels within IC 152 across the different subsystems (e.g., compute circuit types), connectivity of kernels within IC 152, and/or data access patterns of the kernels. A data access pattern refers to the pattern of reading data and/or writing data as implemented by a kernel. The traffic generator kernels contained within traffic generator designs of design library 172, unlike kernels included in actual applications implemented in IC 152 or other SoC (e.g., application-specific kernels), may be configurable in a variety of different aspects whether at compile time and/or at runtime.

For example, a traffic generator design intended to mimic operation of a machine-learning based inference application will include traffic generator kernels allocated to those subsystems of IC 152 determined to be commonly used by the class of machine-learning based inference applications. The traffic generator kernels are configurable to implement data traffic patterns that mimic the data traffic patterns of actual and corresponding kernels of the application being emulated. As such, the traffic generator design of design library 172 that is intended to mimic operation of a machine-learning based inference application is able to model or mimic the runtime behavior of the machine-learning based inference application in terms of data throughput, speed, data movement, and the like. Such is the case without the traffic generator design performing the actual functions performed by the application being emulated (e.g., without performing inference in this particular example).

Host application library 174 includes a plurality of different host traffic generator applications that may be executed by one or more cores of processor system 166. Each host traffic generator application is intended to emulate one or more application-specific functions as performed by one or more cores of processor system 166 of IC 152. For example, for a given application, processor system 166 may execute program code concurrently with one or more kernels implemented in other subsystems of IC 152. The program code and the kernels may interact with one another. In this example, a user may select a host traffic generator application to execute in processor system 166 concurrently with one or more other traffic generator kernels of a user-specified traffic generator design selected from design library 172.

Working through EDA application 116, a user may provide one or more configuration parameters as input (e.g., user input 120). The configuration parameters may select a traffic generator design 176 from design library 172, where traffic generator design 176 is provided to accelerator 150 and loaded into IC 152. The configuration parameters may select one or more host traffic generator applications 178 that are provided to accelerator 150 and loaded into IC 152 (e.g., into processor system 166). In the examples described herein, a host traffic generator application may be formed of one or more traffic generator kernels that are executable by processor system 166.

In providing traffic generator design 176 and optionally one or more host traffic generator applications 178, both may be conveyed to IC 152 as configured by the user using EDA application 116. In addition, the user, working through EDA application 116, may provide one or more runtime parameters 180 to accelerator 150 and IC 152 to effectuate changes in one or both of traffic generator design 176 and host traffic generator application(s) 178 during runtime (e.g., during operation or execution in IC 152). In one aspect, the runtime parameters 180 may turn particular traffic generator kernels, whether part of traffic generator design 176 or part of host traffic generator application 178, on or off in real time during runtime.

During operation of traffic generator design 176 and/or host traffic generator application(s) 178 in IC 152, performance data is generated and collected. The performance data may indicate quantities such as data throughput of particular traffic generator kernels, data throughput of particular subsystems of IC 152, data throughput of particular interfaces of IC 152, and the like. The performance data is output from IC 152 to data processing system 102 as results 182. Having obtained results 182, EDA application 116 also may perform analysis on results 182 to determine whether certain user specified metrics and/or requirements have been met. EDA application 116 may also provide one or more recommendations to the user based on the analysis of results 182 performed.

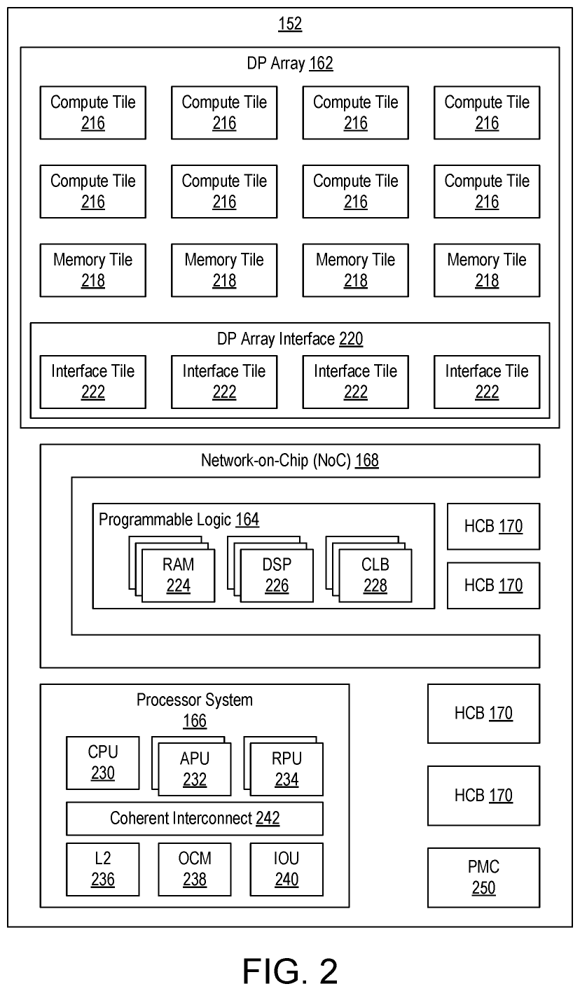

FIG. 2 illustrates an example implementation of IC 152. IC 152 is an example of a programmable IC, an adaptive system, and/or an SoC. In the example of FIG. 2, IC 152 is implemented on a single die provided within a single package. In other examples, IC 152 may be implemented using a plurality of interconnected dies within a single package where the various resources of IC 152 (e.g., circuits) illustrated in FIG. 2 are implemented across the different interconnected dies.

In the example of FIG. 2, IC 152 includes a plurality of different subsystems including data processing array 162, PL 164, processor system 166, NoC 168, a platform management controller (PMC) 250, and one or more hardwired circuit blocks (HCBs) 170.

Data processing array 162 is implemented as a plurality of interconnected and programmable tiles. The term “tile,” as used herein, means a block or portion of circuitry also referred to as a “circuit block.” As illustrated, data processing array 162 includes a plurality of compute tiles 216 organized in an array and optionally a plurality of memory tiles 218. Data processing array 162 also includes a data processing array interface 220 having a plurality of interface tiles 222.

In the example, compute tiles 216, memory tiles 218, and interface tiles 222 are arranged in an array (e.g., a grid) and are hardwired. Each compute tile 216 can include one or more cores (e.g., a processor) and a memory (e.g., a random-access memory (RAM)). Each memory tile 218 may include a memory (e.g., a RAM). In one example implementation, cores of compute tiles 216 may be implemented as custom circuits that do not execute program code. In another example implementation, cores of compute tiles 216 are capable of executing program code stored in core-specific program memories contained within each respective core.

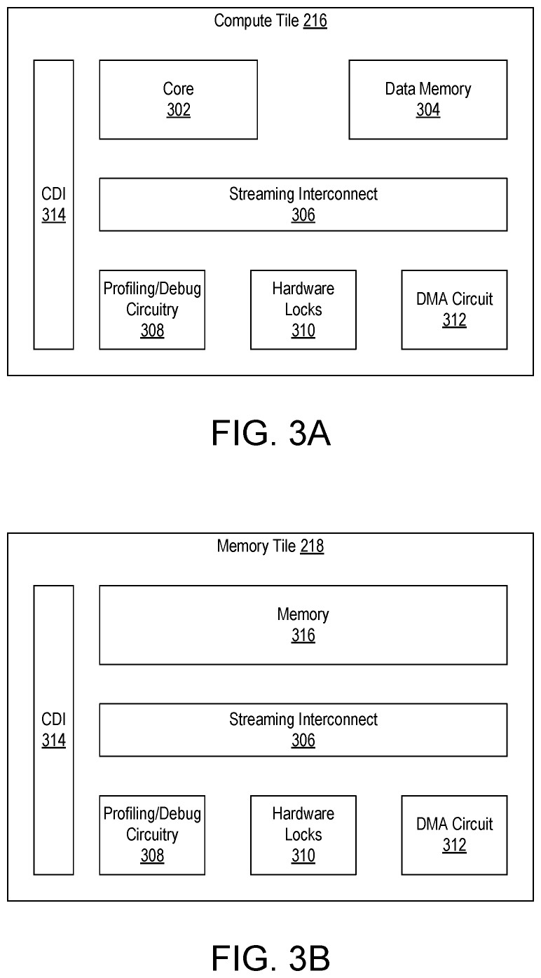

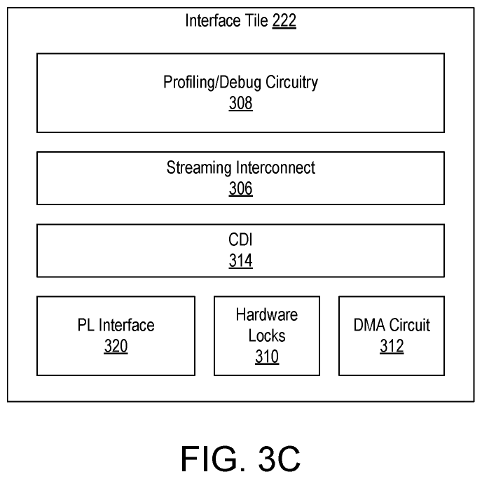

FIGS. 3A, 3B, and 3C illustrate examples of different tiles included in data processing array 162. Referring to the example of FIG. 3A, each compute tile 216 includes a core 302, a data memory 304, a streaming interconnect 306, profiling/debug circuitry 308, hardware locks 310, a direct memory access (DMA) circuit 312, and a configuration and debug interface (CDI) 314. Within this disclosure, DMA circuits are examples of data movers. The cores 302 of compute tiles 216 may be implemented with a Very-Long Instruction word architecture. In one or more examples, each core 302 of a compute tile 216 may be implemented as a vector processor capable of performing both fixed and floating-point operations and/or a scalar processor. The data memory 304 of a compute tile 216 may be implemented as a RAM. The core 302 of a compute tile 216 is capable of directly accessing the data memory 304 in the same compute tile 216 and in other adjacent compute tiles 216. The core 302 also has direct connections referred to as cascade connections to other cores 302 in adjacent compute tiles 216 so that data may be conveyed directly between cores 302 without writing such data to a data memory 304 (e.g., without using shared memory to communicate data) and/or without conveying data over streaming interconnects 306 to other tiles.

Streaming interconnect 306 provides dedicated multi-bit data movement channels connecting to streaming interconnects 306 in each adjacent tile in the north, east, west, and south directions of data processing array 162. DMA circuit 312 is coupled to streaming interconnect 306 and is capable of performing DMA operations to move data into and out from data memory 304 by way of streaming interconnect 306. Hardware locks 310 facilitate the safe transfer of data to/from data memory 304 and other adjacent and/or non-adjacent tiles. CDI 314 may be implemented as a memory mapped interface providing read and write access to any memory location within compute tile 216. Profiling/debug circuitry 308 may include event detection circuitry and/or performance counters for generating performance data. Profiling/debug circuitry may be configured via CDI 314. Compute tile 216 may include other circuit blocks not illustrated in the general example of FIG. 3A.

FIG. 3B illustrates an example implementation of a memory tile 218. In the example, memory tiles 218 include a memory 316, a streaming interconnect 306, profiling/debug circuitry 308, hardware locks 310, a DMA circuit 312, and a CDI 314. Memory 316 may have a larger capacity than data memory 304. DMA circuit 312 of each memory tile 218 may access the memory 316 within the same tile as well as the memory 316 of one or more adjacent memory tiles 218. In general, memory tile 218 is characterized by the lack of a processor and the inability to execute program code. Each memory tile 218 may be read and/or written by any of compute tiles 216 and/or interface tiles 222 by way of interconnected streaming interconnects 306. Memory tile 218 may include other circuit blocks not illustrated in the general example of FIG. 3B.

Data processing array interface 220 connects compute tiles 216 and/or memory tiles 218 to other resources of IC 152. As illustrated, data processing array interface 220 includes a plurality of interconnected interface tiles 222 organized in a row. In one example, each interface tile 222 may have a same architecture. In another example, interface tiles 222 may be implemented with different architectures where each different interface tile architecture supports communication with a different type of resource (e.g., subsystem) of IC 152. Interface tiles 222 of data processing array interface 220 are connected so that data may be propagated from one interface tile to another bi-directionally. Each interface tile is capable of operating as an interface for the column of compute tiles 216 and/or memory tiles 218 directly above.

FIG. 3C illustrates an example implementation of an interface tile 222. In the example, interface tile 222 includes a PL interface 320, a streaming interconnect 306, profiling/debug circuitry 308, hardware locks 310, a DMA circuit 312, and a CDI 314. Interface tile 222 may include other circuit blocks not illustrated in the general example of FIG. 3C. The example interface tile 222 of FIG. 3C is capable of communicating with the PL 164 via PL interface 320 and NoC 168 via DMA circuit 312. Other example architectures for interface tile 222 may omit interface 320 or omit DMA circuit 312.

PL 164 is circuitry that may be programmed to perform specified functions. As an example, PL 164 may be implemented as field programmable gate array type of circuitry. PL 164 can include an array of programmable circuit blocks. The programmable circuit blocks may include, but are not limited to, RAMs 224 (e.g., block RAMs of varying size), digital signal processing (DSP) blocks 226 capable of performing various multiplication operations, and/or configurable logic blocks (CLBs) 228 each including one or more flip-flops and a lookup table. As defined herein, the term “programmable logic” means circuitry used to build reconfigurable digital circuits. The topology of PL 164 is highly configurable unlike hardwired circuitry. Connectivity among the circuit blocks of PL 164 may be specified on a per-bit basis while the tiles of data processing array 162 are connected by multi-bit data paths (e.g., streams) capable of packet-based communication.

Processor system 166 is implemented as hardwired circuitry that is fabricated as part of IC 152. Processor system 166 may be implemented as, or include, any of a variety of different processor types each capable of executing program code. For example, processor system 166 may include a central processing unit (CPU) 230, one or more application processing units (APUs) 232, one or more real-time processing units (RPUs) 234, a level 2 (L2) cache 236, an on-chip memory (OCM) 238, an Input/Output Unit (IOU) 240, each interconnected by a coherent interconnect 242. The example CPU and/or processing units of processor system 166 may be implemented using any of a variety of different types of architectures. Example architectures that may be used to implement processing units of processor system 166 may include, but are not limited to, an ARM processor architecture, an x86 processor architecture, a graphics processing unit (GPU) architecture, a mobile processor architecture, a DSP architecture, combinations of the foregoing architectures, or other suitable architecture that is capable of executing computer-readable instructions or program code.

NoC 168 is a programmable interconnecting network for sharing data between endpoint circuits in IC 152. NoC 168 may be implemented as a packet-switched network. The endpoint circuits can be disposed in data processing array 162, PL 164, processor system 166, and/or selected HCBs 170. NoC 168 can include high-speed data paths with dedicated switching. In an example, NoC 168 includes one or more horizontal paths, one or more vertical paths, or both horizontal and vertical path(s). NoC 168 is an example of the common infrastructure that is available within IC 152 to connect selected components and/or subsystems.

Being programmable, nets that are to be routed through NoC 168 may be unknown until a design is created and routed for implementation within IC 152. NoC 168 may be programmed by loading configuration data into internal configuration registers that define how elements within NoC 168 such as switches and interfaces are configured and operate to pass data from switch to switch and among the NoC interfaces to connect the endpoint circuits. NoC 168 is fabricated as part of IC 152 (e.g., is hardwired) and, while not physically modifiable, may be programmed to establish logical connectivity between different primary circuits and different secondary circuits of a user circuit design.

PMC 250 is an optional subsystem within IC 152 that is capable of managing the other programmable circuit resources (e.g., subsystems) across the entirety of IC 152. PMC 250 is capable of maintaining a safe and secure environment, booting IC 152, and managing IC 152 during normal operations. For example, PMC 250 is capable of providing unified and programmable control over power-up, boot/configuration, security, power management, safety monitoring, debugging, and/or error handling for the different subsystems of IC 152 (e.g., data processing array 162, PL 164, processor system 166, NoC 168, and/or HCBs 170). In one aspect, PMC 250 operates as a dedicated platform manager that decouples processor system 166 from PL 164. As such, processor system 166 and PL 164, as well as selected ones of the other subsystems, may be managed, configured, and/or powered on and/or off independently of one another.

HCBs 170 are special-purpose or application-specific circuit blocks fabricated as part of IC 152. Though hardened, HCBs 170 may be configured by loading configuration data into control registers to implement one or more different modes of operation. Examples of HCBs 170 may include input/output (I/O) blocks (e.g., single-ended and pseudo differential I/Os), transceivers for sending and receiving signals to circuits and/or systems external to IC 152 (e.g., high-speed differentially clocked transceivers), memory controllers, cryptographic engines, digital-to-analog converters (DACs), analog-to-digital converters (ADCs), and the like.

The various programmable circuit resources illustrated in FIGS. 1, 2, and 3 may be programmed initially as part of a boot process. During runtime, the programmable circuit resources may be reconfigured. In one aspect, PMC 250 is capable of initially configuring data processing array 162, PL 164, processor system 166, and NoC 168. At any point during runtime, PMC 250 may reconfigure all or a portion of IC 152. In some cases, processor system 166 may configure and/or reconfigure PL 164 and/or NoC 168 once initially configured by PMC 250. In cases where PMC 250 is omitted, processor system 166 may configure and/or reconfigure subsystems of IC 152.

FIGS. 1, 2, and 3 are provided as examples. Other example implementations for an IC may omit certain subsystems described herein and/or include additional subsystems not described herein. Further, the particular subsystems described herein may be implemented differently to have fewer or more components than shown. Particular components common across different tiles of the data processing array and having same reference numbers such as streaming interconnects 306, CDIs 314, DMA circuits 312, profiling/debug circuitry 308, and the like have substantially the same functionality from one tile to another. It should be appreciated, however, that the particular implementation of such circuit blocks may differ from one type of tile to another. As an illustrative and non-limiting example, the number of ports of the streaming interconnect 306 may be different for a compute tile 216 compared to a memory tile 218 and/or an interface tile 222. Similarly, the number of channels of a DMA circuit 312 may be different in a compute tile 216 compared to a memory tile 218 and/or an interface tile 222. In another example, the number of events that may be detected by and/or counters included in profiling/debug circuitry 308 in one type of tile may differ from the number of events that are detectable by and/or counters included in profiling/debug circuitry 308 in a different type of tile. In other examples, the circuit blocks may be implemented the same across different tiles.

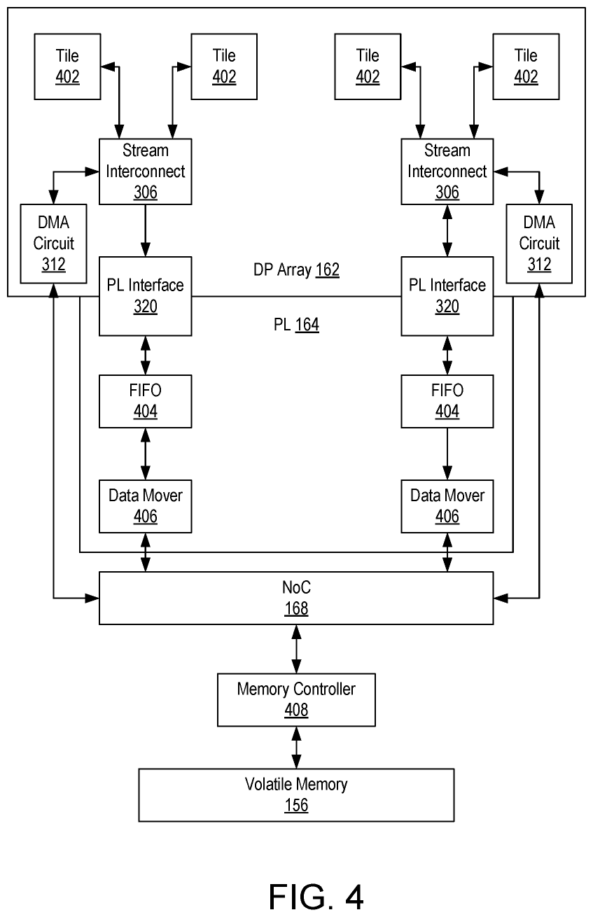

FIG. 4 illustrates example connectivity between data processing array 162 other subsystems of IC 152. In the example of FIG. 4, tiles 402 may represent compute tiles 216, memory tiles 218, interface tiles 222, or any combination thereof. Data may be exchanged between data processing array 162 and PL 164 using a DMA-based option referred to as “Global Memory Input/Output” or “GMIO.” Data also may be exchanged between data processing array 162 and PL 164 via PL interfaces 320 referred to as “Programmable Logic Input/Output” or “PLIO.” Any application implemented in IC 152 and/or traffic generator design may be implemented to use GMIO only, PLIO only, or a combination of both GMIO and PLIO. Both of the GMIO option and the PLIO option access memory controller 408 via NoC 168 albeit through different pathways.

The GMIO option routes data by way of stream interconnects 306 to DMA circuits 312 to NoC 168. Via this pathway, data may be read from volatile memory 156 by traffic generator kernels implemented in tiles 402 and/or written to volatile memory 156 by traffic generator kernels implemented in tiles 402. In the GMIO option, DMA circuits 312 may be directly coupled to NoC 168 to exchange data. That is, DMA circuits 312 may be directly coupled to NoC 168 so as not to utilize or require any circuit resources of PL 164 to establish the connections illustrated.

In the PLIO option, data is routed through PL 164. In the example, data traverses a path that includes a first-in-first-out (FIFO) memory 404 and a data mover 406. Each data mover 406 couples to NoC 168. Each FIFO memory 404 couples to a PL interface 320 of an interface tile 222. It should be appreciated that the particular implementation of data paths through PL 164 may vary from that illustrated in FIG. 4. For example, data paths in PL 164 may merge and enter NoC 168 through a single NoC interface rather than the multiple connection points illustrated. Further, more than two data paths may be implemented in PL 164.

For purposes of illustration, both the GMIO and the PLIO options are illustrated as being implemented concurrently. As noted, however, some traffic generator designs may use only one of the two options. In the example, the data movers 406 and the DMA circuits 312 (e.g., also data movers) are configured to convert streaming data to memory-mapped data.

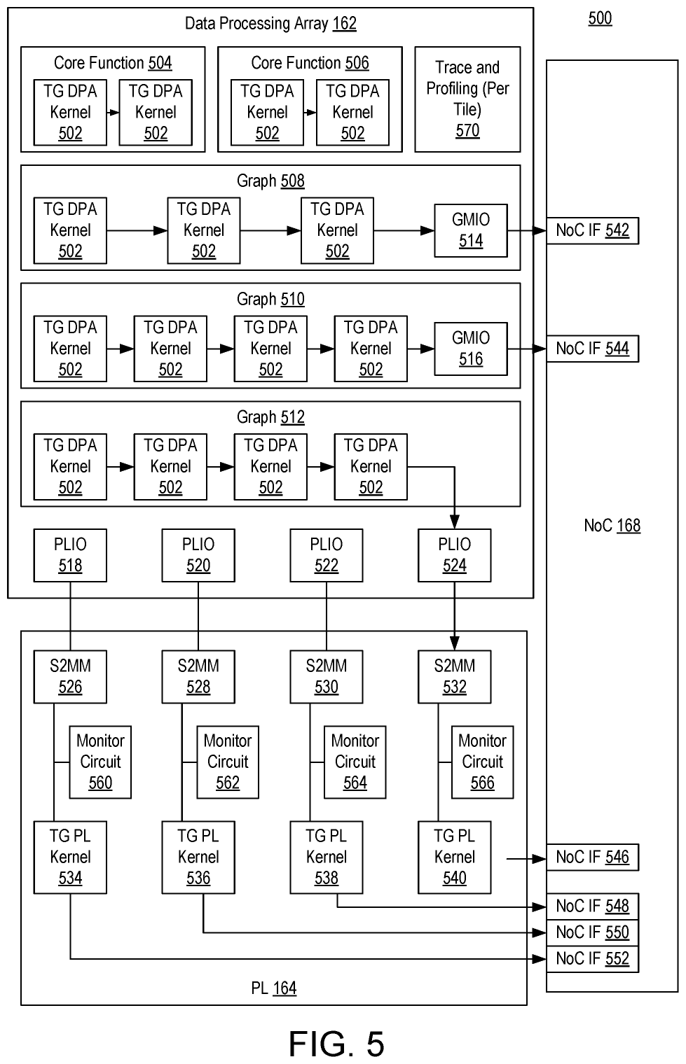

FIG. 5 illustrates an example of a traffic generator design 500 as may be stored in design library 172. In the example, traffic generator design 500 is a pre-built design that includes traffic generator kernels implemented in both the data processing array 162 (traffic generator DPA kernels) and in the PL 164 (traffic generator PL kernels).

Referring to the portion of traffic generator design 500 implemented in data processing array 162, the traffic generator DPA kernels 502 are arranged in core functions 504, 506, and in graphs 508, 510, and 512. As illustrated, graph 508 may exchange data with NoC 168 using GMIO 514. Graph 510 may exchange data with NoC 168 using GMIO 516. In the example, each GMIO 514, 516 represents a DMA circuit 312 of an interface tile 222. In the example, GMIOs 514 and 516 couple to NoC 168 via NoC interfaces 542 and 544 respectively. Traffic generator DPA kernels 502 disposed in core function 504 and in core function 506 may communicate with portions of IC 152 external to data processing array 162 by way of a GMIO (not shown) or a PLIO (not shown).

An example of a basic core function may include, but is not limited to, matrix multiplication. That is, a core function such as core function 504 and/or 506 may mimic operation of a matrix multiplication function that is not part of a larger graph. In one or more examples, the same basic core function may be implemented in other types of traffic generator kernels such as one or more traffic generator PL kernels and/or in a host traffic generator application where each mimics operation of a matrix multiplication function albeit in the particular subsystem in which the traffic generator kernel is intended to operate. This allows a user to determine the performance attainable for that core function in each respective subsystem including seeing how performance is affected due to data movement for the core function as well as other emulated functions in other subsystems of IC 152.

Data processing array 162 includes PLIOs 518, 520, 522, and 524. In the example, PLIO 524 is used by graph 512 to move data into and/or out from data processing array 162. PLIOs 518, 520, and 522 may connect to other graphs and/or core functions implemented in data processing array 162 not illustrated in the example of FIG. 5.

PLIOs 518, 520, 522, and 524 are coupled to respective ones of S2MMs 526, 528, 530, and 532. Each S2MM represents a “stream-to-memory-mapped” circuit that is configured to convert streaming data as received from data processing array 162 into memory-mapped data that may be conveyed to other circuits with memory-mapped interfaces such as kernels implemented in PL 164 and/or NoC 168.

As illustrated, data generated by graph 512 may be output via PLIO 524 to S2MM 528 and on to a traffic generator PL kernel 540. PL 164 may implement other traffic generator PL kernels 534, 536, and 538 that may be coupled to other graphs implemented in data processing array 162 that are not illustrated in the example of FIG. 5.

Traffic generator PL kernels 534, 536, 538, and 540 couple to NoC 168 via NoC interfaces 546, 548, 550, and 552, respectively. It should be appreciated that traffic generator PL kernels 534, 536, 538, and/or 540 may be coupled to one another and/or to NoC 168 depending on the particular traffic generator design implemented in IC 152. In the example, traffic generator PL kernels 534, 536, 538, and 540 provide data to NoC 168. Traffic generator PL kernel 538 also provides data to traffic generator PL kernel 540. For example, traffic generator PL kernel 540 may emulate the operation of a kernel that operates on data received from another kernel implemented in PL 164 and on data received from data processing array 162.

In the example, each traffic generator kernel, whether implemented in data processing array 162 or in PL 164, is configurable from user-specified configuration parameters to generate data to emulate a particular data throughput (output a particular amount of data), to emulate a particular data access pattern (e.g., reading of and/or writing of data to a particular location such as a memory or other traffic generator), and/or to use particular data paths in implementing the data access pattern.

The traffic generator designs also include built-in profiling and trace monitoring functions for the different hardware elements. As an illustrative and non-limiting example, each of the traffic generator DPA kernels 502 may be implemented in a different compute tile 216 of data processing array 162. The compute tiles 216, as do other tiles such as memory tiles 218 and/or interface tiles 222, include profiling/debug circuitry 308 capable of performing trace and/or profiling functions 570. The trace and profiling functions 570 may be implemented on a per tile basis by way of profiling/debug circuitry 308 where tiles are configured to count particular hardware events such as the sending of data and/or counting the events and/or the amount of data sent and/or received (e.g., measuring data throughput for the tile), and the like.

Similarly, each of the NoC interfaces 542-552 can include trace and profiling capabilities to measure average data throughput through each respective NoC interface and measure the latency in sending data to volatile memory 156 and/or in receiving data from volatile memory 156. For example, each NoC interface may include profiling/debug circuitry 308 or other similar circuitry with event detection and/or counter capabilities. The counters, whether in NoC interfaces or in tiles of data processing array 162, may be sampled (e.g., read and output from IC 152) from time-to-time or periodically. The counters, whether in NoC 168, data processing array 162, and/or monitor circuits, allow one to determine bandwidth, how much data is passing through each respective data path, and/or the latency of transactions conveyed over that data path.

Further profiling capabilities may be implemented through inclusion of monitor circuits 560, 562, 564, and 566 on each of the data paths between an S2MM and corresponding traffic generator PL kernel. Each monitor circuit is capable of measuring the amount of data (e.g., data throughput) on the coupled data path, counting particular events occurring on the data path, and the like. In general, the monitor circuits implemented in PL 164 may provide the same or similar functionality as profiling/debug circuitry 308. The performance data generated by the monitor circuits, the respective tiles of the data processing array 162, and the NoC interfaces may be output from IC 152 as results 182.

In some cases, hardware limitations may exist that limit how much activity may be monitored during a given run or execution of the traffic generation design. For example, the profiling/debug circuitry 308 of compute tiles 216 may have a limited number of counters (e.g., four) and/or trace event slots for specifying the hardware events that are to be detected and tracked or counted by the counters. In one or more example implementations, the selected traffic generator design may be run or executed multiple times with the performance and/or trace functionality being reconfigured for each different run to capture different performance data in each run. That is, the counters and/or trace event slots may be reset and/or reprogrammed between runs to detect different events, count different events and/or data, etc. for each different run of the same traffic generator design. After the run is over, a back-end analysis process executed by data processing system 102 may merge the results 182 from the various profiling/debug circuitry 308 and monitor circuits in PL 164. The back-end process (e.g., as performed by EDA application 116) is capable of merging the results 182 to provide users with a complete understanding and view of the performance data.

In selecting a particular traffic generator design for implementation in IC 152, the available options may include, the number of graphs executing in the data processing array, the length or size of each graph in terms of a number of traffic generator DPA kernels forming each graph, whether particular traffic generator DPA kernels 502 broadcast data to one or a plurality of other tiles with traffic generator DPA kernels 502 implemented therein, the number of other tiles to which a given tile broadcasts data, and the particular interface (GMIO or PLIO) to be used by each respective graph. As illustrated, each graph within the data processing array 162 operates as a separate application in that each graph may have its own input(s) and output(s) and operate in parallel and independently of other graphs implemented in data processing array 162. There is no connection between different graphs within data processing array 162 itself. Graphs may be coupled through data pathways implemented in IC 152 that are external to data processing array 162 and/or via one or more data pathways external to IC 152.

Different traffic generator designs may also include different numbers of traffic generator PL kernels, have different connectivity between graphs and traffic generator PL kernels, different connectivity between different traffic generator PL kernels, and different data access patterns for the various kernels (e.g., both traffic generator DPA kernels and traffic generator PL kernels).

The different traffic generator designs may emulate different partitioning of applications. For example, one traffic generator design may mimic operation of an application with particular functions (e.g., kernels) implemented in PL 164 and other functions (e.g., kernels) implemented in the data processing array 162. A different traffic generator design may mimic a different partitioning of the same functions between the PL 164 and the data processing array 162. The way in which data moves around IC 152 (e.g., the particular data paths used, which data paths are shared, the speed of data movement, etc.) will differ from one traffic generator design to another even for the same application.

As an example, consider the case of a multi-layered machine learning application. PL 164 may be better suited to performing particular operations of the application while data processing array 162 is better suited to performing other operations of the application. A first traffic generator design may mimic implementation of one or more particular layers of the application in PL 164 and mimic one or more other layers of the application in data processing array 162. A second and different traffic generator design may have a different partitioning in which different layers are implemented in data processing array 162 and PL 164 than is the case with the first traffic generator design.

In another example, a user may have an application with a data flow in which data is obtained from an external memory (e.g., volatile memory 156) by PL 164, the PL 164 is used to pre-process the data, the pre-processed data is provided from PL 164 to data processing array 162, which performs operations such as inference, and then outputs the resulting data back to the external memory. In that case, the user may select a traffic generator design that mimics that data flow.

In one or more example implementations, each of the traffic generator kernels, whether implemented in data processing array 162 or PL 164, may be programmed with commands for moving data (e.g., dummy data). The various commands can include read commands, write commands, or a combination of read and write commands. Each respective read and/or write command can specify an amount of data that is to be read or written. Each read and/or write command also can specify a “delay” parameter that indicates the amount of time to wait before the traffic generator kernel is to implement the command after the prior command executes (e.g., after the prior transaction completes). In addition, each of the traffic generator kernels can be configured to implement a repeat, e.g., loop, mode. In the repeat mode, the same sequence of commands (e.g., data traffic pattern) can be repeated for a particular number of times as specified through programming of the traffic generator kernel.

Accordingly, each of the traffic generator kernels can be programmed with a sequence of commands that allows each of traffic generator kernels to emulate various types of circuit blocks and/or functions. In one aspect, for example, the sequences of commands can cause a traffic generator kernel to emulate a circuit block that is polled by a processor. In another aspect, the sequences of commands can allow a traffic generator kernel to emulate a circuit block that is interrupt driven, or the like. The sequences of commands also allow a traffic generator kernel to mimic various types of data transfers, including, DMA transfers, or the like. In addition, the sequences of commands can create dependencies among individual ones of traffic generator kernels and between one or more or each respective one of traffic generator kernel and/or cores of processor system 166. Further, the data access patterns allow one to observe overall performance of IC 152 as data is conveyed throughout the chip over various common data pathways such as NoC 168 and/or to and from an external memory.

In one or more example implementations, the data access patterns may be included (e.g., pre-built) as part of each of the traffic generator designs. In another aspect, the user may specify the data access patterns for one or more or all of the traffic generator kernels of a given traffic generator design as user-specified configuration parameters.

In the example of FIG. 5, processor system 166 is not illustrated. In one or more example implementations, processor system 166 may execute control software that is capable of implementing operations such as configuration and/or initialization of data processing array 162 and PL 164. The processor system 166 may operate as the primary with the data processing array 162 and PL 164 operating as the secondaries. In this regard, processor system 166 may initialize, start, and stop data processing array 162 and/or PL 164. Processor system 166 may execute the control software alone or the control software in combination with one or more host traffic generation applications. With the inclusion of one or more host traffic generation applications, processor system 166 is mimicking the performance of computations in addition to performing actual control functions over the emulation. This may allow issues such as memory conflicts to be identified since different host traffic generation applications have different memory requirements and usage scenarios where memory may be shared with PL 164 and/or data processing array 162. Any of the subsystems, e.g., data processing array 162, PL 164, and/or processor system 166 may compete for limited bandwidth over data paths.

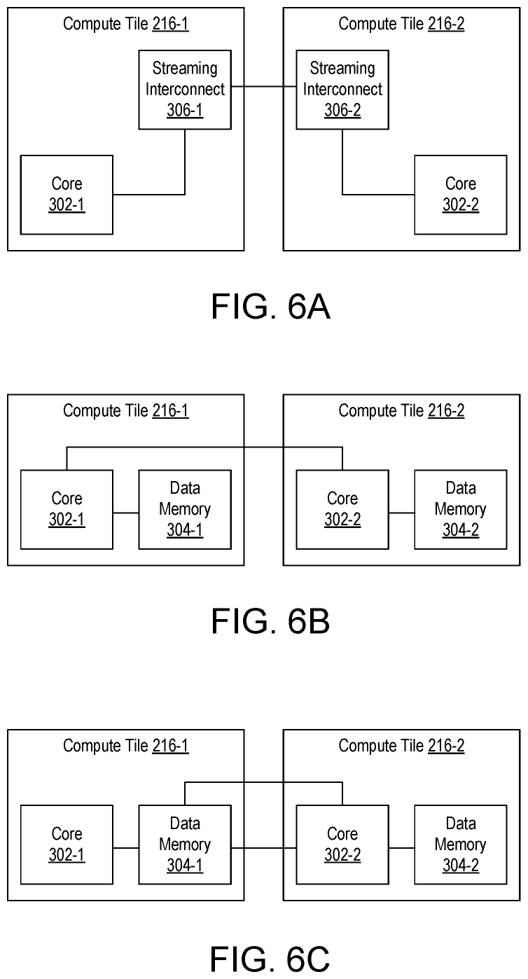

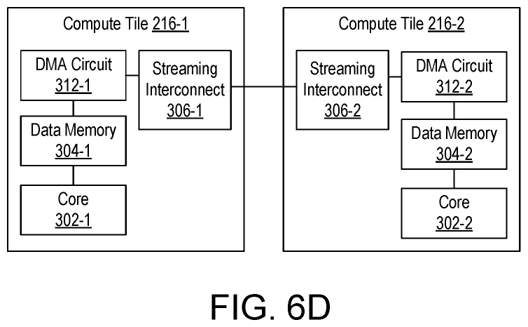

FIGS. 6A, 6B, and 6C illustrate different ways of conveying data among tiles of data processing array 162. FIG. 6A illustrates a streaming interconnect connection between compute tiles. In the example of FIG. 6A, compute tiles 216-1 and 216-2 communicate via a data path formed of streaming interconnects 306. For example, core 302-1 may access (e.g., read and/or write) data stored in data memory 304-2 via streaming interconnect 306-1 coupled to streaming interconnect 306-2 coupled to core 302-2.

FIG. 6B illustrates a cascade connection between cores of adjacent compute tiles 216. In the example of FIG. 6B, core 302-1 conveys data from an internal register therein directly to an internal register in core 302-2 over a connection referred to the cascade connection. In the example of FIG. 6B, the data being conveyed over the cascade connection does not traverse over streaming interconnects 306 and does not require intermediate storage in data memory 304-1 or data memory 304-2.

FIG. 6C illustrates a windowed connection between adjacent compute tiles 216. A windowed connection is also referred to as communicating via shared memory or a shared memory connection. In the example of FIG. 6C, a core may pass data to another core via shared memory. Core 302-2 may share data with core 302-1 by writing the data directly to data memory 304-1. Appreciably, core 302-2 may write data directly to data memory 304-2. Core 302-2 is capable of accessing the data memories shown directly via a memory interface that does not utilize the same data path as the cascade connection of FIG. 6B or the streaming interconnect-based connections of FIG. 6A. Core 302-2, for example, sees data memories 304-1 and 304-2 as a single unified memory space allowing data to be passed between cores 302-1 and 302-2 in the manner described.

FIG. 6D illustrates another example connection between compute tiles 216. In the example of FIG. 6D, core 302-1 may access data memory 304-1, which may be accessed by DMA circuit 312-1, which couples to streaming interconnect 306-1, which communicates with streaming interconnect 306-2, which couples to DMA circuit 312-2, which accesses data memory 304-2, which may be accessed by core 302-2.

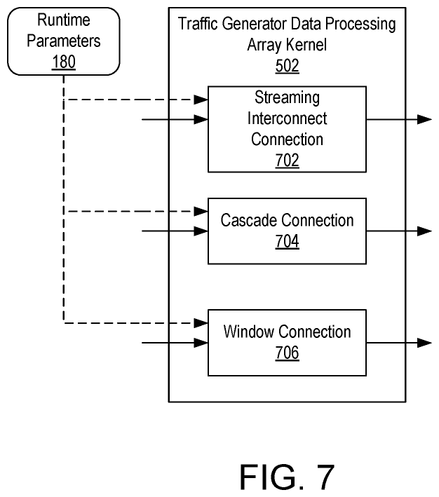

FIG. 7 illustrates certain operative features of runtime parameters 180. In the example, runtime parameters 180 may be provided to any of the traffic generator DPA kernels 502 during runtime or operation of the traffic generator design in IC 152. Each of the runtime parameters 180 allows a user to instruct any given traffic generator DPA kernel 502 to convey data to another traffic generator DPA kernel in the same graph (e.g., logically coupled together) via a selected data path. The available data paths correspond to those of FIG. 6, e.g., a streaming interconnect connection 702, a cascade connection 704, or via a window connection 706 (e.g., shared memory). In this regard, the traffic generator DPA kernel is configurable during runtime to convey the dummy data being generated via the particular data path specified by the runtime parameters. This allows the user to change the manner in which the traffic generator DPA kernels communicate or convey data in real time during runtime to observe changes in performance.

In another example implementation, the runtime parameters 180 may include an instruction to begin mimicking the performance of vector operations and the conveyance of such data to one or more other traffic generator DPA kernels. Another example of runtime parameters 180 includes activate and deactivate commands that may be provided to traffic generator DPA kernels to active and/or deactivate particular graphs executing in data processing array 162 as selected by the user. Deactivating a particular graph means that the graph no longer consumes or generates dummy data.

Other examples of runtime parameters 180 that may be conveyed to selected traffic generation kernels which are not limited to use with traffic generator DPA kernels include bandwidth throttling (e.g., changing the amount and/or duration of the dummy data being generated). Like the traffic generator DPA kernels, traffic generator PL kernels may be provided with activate and/or deactivate commands thereby allowing a user to specify which traffic generator PL kernels to activate and/or deactivate at any given time during runtime of the traffic generator design. In any case, the runtime parameters 180 described herein may be provided to one or more traffic generator kernels as specified by the user to change the manner of execution of the traffic generator design during runtime.

Through EDA application 116, the user may provide any necessary input (e.g., user input 120) for selecting, implementing, and/or controlling a traffic generator design and/or host traffic generator application. EDA application 116 is also capable of receiving results 182. EDA application 116 is capable of visualizing results 182 and is also capable of analyzing results 182.

In one or more examples, the user may provide particular requirements as input (e.g., user input 120) defining use-desired performance from the traffic generator design and/or the host traffic generator application in IC 152. The requirements may specify a desired bandwidth for processing certain data, bandwidth requirements for accessing data from the external memory or other data paths implemented in IC 152, latency for certain data accesses, and the like. EDA application 116 is also capable of comparing the results 182 with the user-specified requirements and indicating whether the user-specified requirements were achieved.

In one or more examples, EDA application 116 may provide recommendations for improving performance. For example, EDA application 116 may data mine results 182 to determine particular recommendations for improving performance and/or achieving the user-specified performance requirements. As an illustrative and nonlimiting example, EDA application 116 may be programmed with knowledge of the maximum bandwidth supported by certain components and/or data paths of IC 152 such as NoC 168, NoC interfaces, volatile memory 156, GMIOs, PLIOs, and the like. In response to observing that the bandwidth requirement of the user was not met, EDA application 116 may recommend alternative data paths.

As an illustrative and nonlimiting example, in response to determining that a user-specified requirement for NoC 168 bandwidth was not met, EDA application 116 may recommend that the user use a PLIO rather than a GMIO for conveying data in and/or out of data processing array 162 for a particular graph or graphs. In another example, the EDA application 116 may indicate that the maximum bandwidth for accessing volatile memory 156 is exceeded. As part of the visualization noted, EDA application 116 may provide the percentages of bandwidth used or available for particular data paths (e.g., PLIOs, GMIOs, memory controller(s), NoC 168, and/or NoC interfaces).

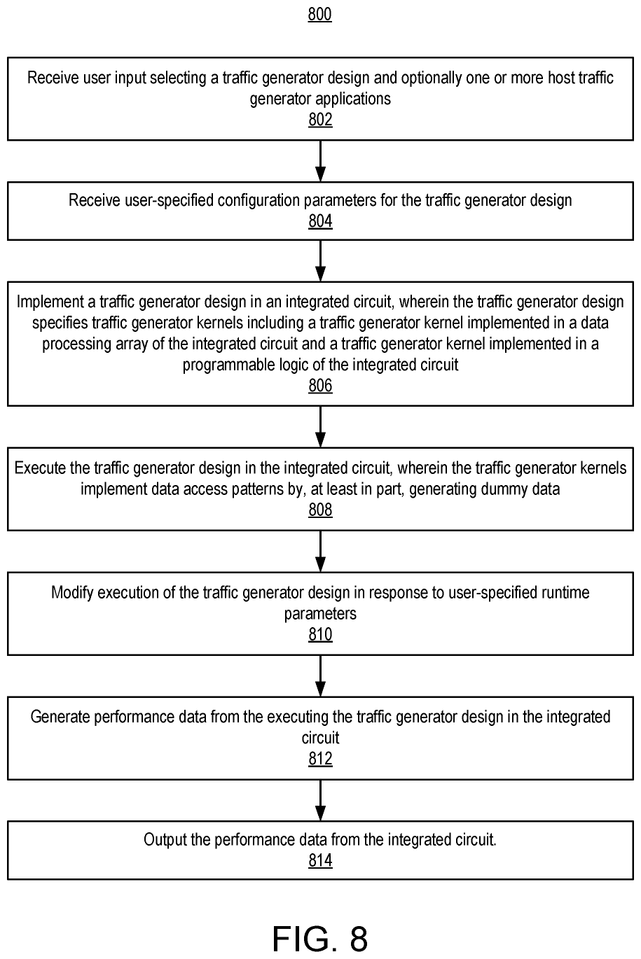

FIG. 8 illustrates an example method 800 determining and/or evaluating the performance of a heterogeneous hardware platform. Method 800 may be performed using the computing environment 100 of FIG. 1.

In block 802, data processing system 102, in executing EDA application 116, receives user input. The user input may specify a selected traffic generator design from design library 172. The user input may also specify one or more host traffic generator applications from host application library 174.

In block 804, optionally, data processing system 102, in executing EDA application 116, receives user-specified configuration parameters for the traffic generator design as selected. In one or more aspects, the user-specified configuration parameters specify particular data access patterns to be implemented by the respective traffic generator kernels (e.g., commands as previously described or a particular pre-built data access pattern). The user-specified configuration parameters may specify selected interfaces to be used between the data processing array 162 and one or more other subsystems (e.g., PL 164, processor system 166, and/or NoC 168) of IC 152. The interfaces, for example, may be GMIO interface(s) and/or PLIO interface(s). The interfaces may be specified for each core function and/or graph implemented in data processing array 162 as part of the selected traffic generator design. The user-specified configuration parameters may specify a number of graphs to be implemented in data processing array 162. Each graph includes one or more traffic generator kernels (e.g., traffic generator DPA kernels). The user-specified configuration parameters may specify a number of kernels on a per-graph basis. The user-specified configuration parameters may specify whether selected traffic generator kernels implemented in data processing array 162 broadcast data to a plurality of other (e.g., destination) traffic generator kernels in data processing array 162 or convey data to a single or particular destination traffic generator kernel in data processing array 162. If data is broadcast, the user-specified configuration parameters may specify the number of destination traffic generator kernels receiving broadcast data from a broadcasting traffic generator kernel. Accordingly, data processing system 102, in executing EDA application 116, is capable of configuring (e.g., modifying) the traffic generator design to implement any of the various implementation options described herein based on the received user-specified configuration data.

In one or more other example implementations, the selected traffic generator design may be preconfigured with certain implementation options such that user-specified configuration parameters need not be received from the user. In other examples, one or more of the noted items may be received from the user to override default implementation options of a traffic generator design.

In block 806, the traffic generator design, e.g., as selected, is implemented in IC 152. Implementing the traffic generator design in IC 152 means that the traffic generator design is physically realized in IC 152. As discussed, the traffic generator design that is selected is a pre-created design and may be specified as a bitstream used to program programmable resources of IC 152. The selected traffic generator design may be a pre-configured bitstream and/or a bitstream that may be further configured based on user-specified parameters. The traffic generator design, as implemented, specifies traffic generator kernels. The traffic generator kernels of the traffic generator design, as implemented in IC 152, include one or more traffic generator kernels implemented in data processing array 162 of IC 152 and one or more traffic generator kernels implemented in PL 164 of IC 152.

In block 808, the traffic generator design in IC 152 is executed. In executing the traffic generator design, the traffic generator kernels implement data access patterns by, at least in part, generating dummy data. In some aspects, the data access patterns implemented by the traffic generator kernels mimic data access patterns of application-specific kernels (e.g., kernels configured to perform actual functions for an application). As discussed, in one or more examples, processor system 166 may execute a control application that controls the operation of the traffic generator design (e.g., initialization, start, and/or stop).

In block 810, optionally execution of the traffic generator design in IC 152 is modified in response to receiving runtime parameters 180. For example, a user may provide one or more runtime parameters to EDA application 116. EDA application 116 may provide the runtime parameters to IC 152 to modify the manner in which the traffic generator design and/or the host traffic generator application execute. For example, EDA application 116 may provide the runtime parameters to host processor 166 executing the control application. The control application may perform any necessary reconfiguration and/or writing of the runtime parameters to respective configuration registers of the circuit blocks affected. Accordingly, selected graphs may be activated and/or deactivated in real time. Selected traffic generator kernels may be activated and/or deactivated in real time. Selected host traffic generator application(s) may be activated or deactivated in real time.

In some aspects, the traffic generator kernel of data processing array 162 is executed in a first tile (e.g., compute tile 216) of data processing array 162 and sends data over a first data path of a plurality of data paths to a second tile (e.g., another compute tile 216) of data processing array 162. The runtime parameters cause the traffic generator kernel of data processing array 162 to send data over a second and different data path of the plurality of data paths to the second tile. In some aspects, the plurality of data paths include a shared memory connection, a cascade connection, and a streaming interconnect connection.

In block 812, performance data from executing the traffic generator design in IC 152 is generated. For example, performance data may be generated by tiles of data processing array 162 that are active and executing traffic generator kernels (e.g., via the profiling/debug circuitry 308). Performance data may be generated by monitor circuits implemented in PL 164. Performance data may be generated by NoC interface circuits. Appreciably, the performance data is generated by tracking the movement of the dummy data (e.g., the operation of the data access patterns by the respective traffic generator kernels and/or host traffic generator application(s)) throughout different points or locations in the IC 152.

In block 814, the performance data may be output from IC 152 as results 182. In one or more examples, the performance data may be output to data processing system 102 via the communication link established between accelerator 150 and data processing system 102. IC 152 may include circuitry that is capable of receiving the various types of performance data described, combining the performance data from the various sources, and outputting the performance data to data processing system 102 as results 182.

In one or more examples, subsequent to outputting results 182, data processing system 102 is capable of performing various operations on results 182. For example, data processing system 102, in executing EDA application 116, is capable of visualizing results 182, data mining results 182, and/or performing analysis on results 182 (e.g., comparing results 182 with certain hardware limits/metrics and/or user-specified requirements). In this regard, based on the operations performed (e.g., analysis and/or data mining), data processing system 102 is capable of providing suggestions or recommendations as to how to improve performance. For example, data processing system 102 may highlight certain bottlenecks in data throughput or highlight other architectural features of the traffic generator design that are limiting the performance achieved (e.g., causing the traffic generator design to not meet user requirements or come close to or hit hardware limitations). Data processing system 102 may provide alternative suggestions as to connectivity among kernels and/or subsystems, alternative architectures (e.g., other alternative traffic generator designs with better expected performance), and/or alternative workloads to be provided to the respective kernels and/or subsystems.

As discussed, in some aspects, based on received user input (e.g., user-specified configuration parameters), a host traffic generator application is implemented in processor system 166 of IC 152. The host traffic generator application may be executed concurrently with the traffic generator design. It should be appreciated that execution of any host traffic generator application(s) in processor system 166 also may be controlled (e.g., initialized, started, and/or stopped) by execution of the control application. The different applications may be executed in different threads and/or in different cores available in processing system 166.

The terminology used herein is for the purpose of describing particular embodiments only and is not intended to be limiting. Notwithstanding, several definitions that apply throughout this document are expressly defined as follows.

As defined herein, the singular forms “a,” “an,” and “the” are intended to include the plural forms as well, unless the context clearly indicates otherwise.

As defined herein, the terms “at least one,” “one or more,” and “and/or,” are open-ended expressions that are both conjunctive and disjunctive in operation unless explicitly stated otherwise. For example, each of the expressions “at least one of A, B, and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without human intervention.

As defined herein, the term “computer-readable storage medium” means a storage medium that contains or stores program instructions for use by or in connection with an instruction execution system, apparatus, or device. As defined herein, a “computer-readable storage medium” is not a transitory, propagating signal per se. The various forms of memory, as described herein, are examples of computer-readable storage media. A non-exhaustive list of examples of computer-readable storage media include an electronic storage device, a magnetic storage device, an optical storage device, an electromagnetic storage device, a semiconductor storage device, or any suitable combination of the foregoing. A non-exhaustive list of more specific examples of a computer-readable storage medium may include: a portable computer diskette, a hard disk, a RAM, a read-only memory (ROM), an erasable programmable read-only memory (EPROM or Flash memory), an electronically erasable programmable read-only memory (EEPROM), a static random-access memory (SRAM), a portable compact disc read-only memory (CD-ROM), a digital versatile disk (DVD), a memory stick, a floppy disk, or the like.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the term “responsive to” and similar language as described above, e.g., “if,” “when,” or “upon,” means responding or reacting readily to an action or event. The response or reaction is performed automatically. Thus, if a second action is performed “responsive to” a first action, there is a causal relationship between an occurrence of the first action and an occurrence of the second action. The term “responsive to” indicates the causal relationship.

As defined herein, the terms “individual” and “user” each refer to a human being.

As defined herein, the term “hardware processor” means at least one hardware circuit. The hardware circuit may be configured to carry out instructions contained in program code. The hardware circuit may be an integrated circuit.

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “output” means storing in physical memory elements, e.g., devices, writing to display or other peripheral output device, sending or transmitting to another system, exporting, or the like.

As defined herein, the term “real time” means a level of processing responsiveness that a user or system senses as sufficiently immediate for a particular process or determination to be made, or that enables the processor to keep up with some external process.

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc. may be used herein to describe various elements. These elements should not be limited by these terms, as these terms are only used to distinguish one element from another unless stated otherwise or the context clearly indicates otherwise.

A computer program product may include a computer-readable storage medium (or media) having computer-readable program instructions thereon for causing a processor to carry out aspects of the inventive arrangements described herein. Within this disclosure, the term “program code” is used interchangeably with the term “program instructions.” Computer-readable program instructions described herein may be downloaded to respective computing/processing devices from a computer-readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations for the inventive arrangements described herein may be assembler instructions, instruction-set-architecture (ISA) instructions, machine instructions, machine dependent instructions, microcode, firmware instructions, or either source code or object code written in any combination of one or more programming languages, including an object-oriented programming language and/or procedural programming languages. Computer-readable program instructions may include state-setting data. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the computer-readable program instructions by utilizing state information of the computer-readable program instructions to personalize the electronic circuitry, in order to perform aspects of the inventive arrangements described herein.

Certain aspects of the inventive arrangements are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by computer-readable program instructions, e.g., program code.

These computer-readable program instructions may be provided to a processor of a computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the operations specified in the flowchart and/or block diagram block or blocks.

The computer-readable program instructions may also be loaded onto a computer, other programmable data processing apparatus, or other device to cause a series of operations to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the inventive arrangements. In this regard, each block in the flowchart or block diagrams may represent a module, segment, or portion of instructions, which comprises one or more executable instructions for implementing the specified operations.

In some alternative implementations, the operations noted in the blocks may occur out of the order noted in the figures. For example, two blocks shown in succession may be executed substantially concurrently, or the blocks may sometimes be executed in the reverse order, depending upon the functionality involved. In other examples, blocks may be performed generally in increasing numeric order while in still other examples, one or more blocks may be performed in varying order with the results being stored and utilized in subsequent or other blocks that do not immediately follow. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
implementing a traffic generator design in an integrated circuit, wherein the traffic generator design includes traffic generator kernels including a traffic generator kernel implemented in a data processing array of the integrated circuit and a traffic generator kernel implemented in a programmable logic of the integrated circuit;
executing the traffic generator design in the integrated circuit, wherein the traffic generator kernels implement data access patterns by, at least in part, generating dummy data;
generating performance data from the executing the traffic generator design in the integrated circuit; and
outputting the performance data from the integrated circuit.

2. The method of claim 1, wherein the data access patterns implemented by the traffic generator kernels mimic data access patterns of application-specific kernels.

3. The method of claim 1, further comprising:
configuring the traffic generator design to implement the data access patterns.

4. The method of claim 1, further comprising:
configuring the traffic generator design to use selected interfaces between the data processing array and one or more other subsystems of the integrated circuit.

5. The method of claim 4, wherein the selected interfaces are selected from a Global Memory Input/Output interface and a Programmable Logic Input/Output interface.

6. The method of claim 1, further comprising:
configuring the traffic generator design to implement a number of graphs in the data processing array, wherein each graph includes one or more traffic generator kernels.

7. The method of claim 1, further comprising:
configuring the traffic generator design so that the traffic generator kernel in the data processing array broadcasts data to a plurality of other traffic generator kernels in the data processing array.

8. The method of claim 1, further comprising:
modifying execution of the traffic generator design in the integrated circuit in response to receiving user-specified runtime parameters.

9. The method of claim 8, wherein the traffic generator kernel of the data processing array is executed in a first tile of the data processing array and sends data over a first data path of a plurality of data paths to a second tile of the data processing array, and wherein the runtime parameters cause the traffic generator kernel of the data processing array to send data over a second and different data path of the plurality of data paths to the second tile.

10. The method of claim 9, wherein the plurality of data paths include a shared memory connection, a cascade connection, and a streaming interconnect connection.

11. The method of claim 8, wherein one or more of the traffic generator kernels are activated or deactivated in response to the user-specified runtime parameters.

12. The method of claim 1, further comprising:
implementing a host traffic generator application in a processor system of the integrated circuit that executes concurrently with the traffic generator design in response to user-specified configuration parameters.

13. An integrated circuit, comprising:
a data processing array configured to implement a first traffic generator kernel of a traffic generator design for the integrated circuit; and
a programmable logic configured to implement a second traffic generator kernel of the traffic generator design;
wherein the traffic generator design is executed in the integrated circuit such that the traffic generator kernels implement data access patterns by, at least in part, generating dummy data; and
wherein the data processing array and the programmable logic are configured to generate performance data from executing the traffic generator design in the integrated circuit.

14. The integrated circuit of claim 13, wherein the data access patterns implemented by the traffic generator kernels mimic data access patterns of application-specific kernels.

15. The integrated circuit of claim 13, wherein the traffic generator design is configurable to implement the data access patterns.

16. The integrated circuit of claim 13, wherein the traffic generator design is configurable using user-specified parameters to use selected interfaces between the data processing array and one or more other subsystems of the integrated circuit.

17. The integrated circuit of claim 13, wherein the traffic generator design is configurable to implement a user-specified number of graphs in the data processing array, wherein each graph includes one or more traffic generator kernels.

18. The integrated circuit of claim 13, wherein execution of the traffic generator design is modified during runtime in response to receiving user-specified runtime parameters.

19. The integrated circuit of claim 18, wherein the first traffic generator kernel is executed in a first tile of the data processing array and sends data over a first data path of a plurality of data paths to a second tile of the data processing array, and wherein the runtime parameters cause the first traffic generator kernel to send data over a second and different data path of the plurality of data paths to the second tile.

20. The integrated circuit of claim 19, wherein the plurality of data paths include a shared memory connection, a cascade connection, and a streaming interconnect connection.
